(19) United States
(12) Patent Application Publication
(10) Pub. No.: US 2013/0073107 A1
(43) Pub. Date: Mar. 21, 2013

(54) NETWORK APPARATUS, ELECTRIC POWER SUPPLY SYSTEM, AND ELECTRIC POWER SUPPLY METHOD

(71) Applicant: Keito SAWADA, Tokyo (JP)

(72) Inventor: Keito SAWADA, Tokyo (JP)

(73) Assignee: RICOH COMPANY, LTD., Tokyo (JP)

(21) Appl. No.: 13/612,394

(22) Filed: Sep. 12, 2012

(30) Foreign Application Priority Data
Sep. 15, 2011 (JP) 2011-202090

(51) Int. Cl. G06F 1/26

(52) U.S. Cl. 700/297

(57) ABSTRACT

A network apparatus includes: a selection unit that selects a power supply for supplying electric power to a load apparatus from among a first power supply stably supplying a certain amount of electric power and a second power supply that is a power accumulating unit for accumulating electric power generated by natural energy, in accordance with a transition state of the load apparatus and an amount of accumulated electric power in the power accumulating unit; and a supply unit that supplies electric power input from the first power supply or the second power supply selected by the selection unit to the load apparatus via a network cable.

### CROSS-REFERENCE TO RELATED APPLICATIONS

The present application claims priority to and incorporates by reference the entire contents of Japanese Patent Application No. 2011-202090 filed in Japan on Sep. 15, 2011.

### BACKGROUND OF THE INVENTION

1. Field of the Invention

The present invention relates to a network apparatus, an electric power supply system, and an electric power supply method.

2. Description of the Related Art

In the past, OA (Office Automation) apparatus is provided with a state in which the OA apparatus is not completely turned off and some of functions thereof are operated (which may be hereinafter referred to as “standby state” as necessary), which is one of transitioning states of the OA apparatus. In general, the power consumption in the standby state is less than that in the normal state; and therefore, the effect of reduction of the power consumption can be obtained.

By the way, when a power supply other than an AC (Alternating Current) power supply, e.g., an energy device using natural energy such as solar power generation is selected as a power supply in the standby state, the power consumption is expected to be reduced more efficiently.

However, when such energy device is selected as the power supply of the CA apparatus, this entails some limitations. For example, when an energy device such as a solar cell is provided in the OA apparatus, the electric power is supplied by accumulating electric power from fluorescent light in an office, and it may be difficult to obtain sufficient electric power. For example, when the energy device is installed outdoors, may be required complicated power supply wires to the OA apparatus. Further, for example, when the CA apparatus is installed near a window in order to solve such complicated power supply wires, this limits the position where the OA apparatus is installed, and may bring about inconvenience in use (Japanese Patent Application Laid-open No. 2010-181996).

There is a need of a network apparatus, an electric power supply system, and an electric power supply method capable of appropriately supplying electric power to a load apparatus.

### SUMMARY OF THE INVENTION

It is an object of the present invention to at least partially solve the problems in the conventional technology.

According to an aspect of the embodiment, a network apparatus includes: a selection unit that selects a power supply for supplying electric power to a load apparatus from among a first power supply stably supplying a certain amount of electric power and a second power supply that is a power accumulating unit for accumulating electric power generated by natural energy, in accordance with a transition state of the load apparatus and an amount of accumulated electric power in the power accumulating unit; and a supply unit that supplies electric power input from the first power supply or the second power supply selected by the selection unit to the load apparatus via a network cable.

According to another aspect of the embodiment, an electric power supply system includes a load apparatus and a network apparatus supplying electric power to the load apparatus via a network cable. The electric power supply system further includes: a power generation apparatus that generates electric power by natural energy; and a power accumulating unit that accumulates electric power generated by the power generation apparatus. The load apparatus includes a current control unit that controls a current that is output from the load apparatus so that the network apparatus detects a transition state of the load apparatus. The network apparatus includes: a selection unit that selects a power supply for supplying electric power to the load apparatus, from among a first power supply stably supplying a certain amount of electric power and a second power supply which is the power accumulating unit, in accordance with the transition state of the load apparatus detected based on a measured value of the current that is output from the load apparatus and an amount of accumulated electric power in the power accumulating unit; and a supply unit that supplies electric power, input from the first power supply or the second power supply selected by the selection unit, to the load apparatus via the network cable.

According to still another aspect of the embodiment, an electric power supply method is executed by an electric power supply system including a load apparatus and a network apparatus that supplies electric power to the load apparatus via a network cable. The electric power supply system further includes: a power generation apparatus that generates electric power by natural energy; and a power accumulating unit that accumulates the electric power generated by the power generation apparatus. The method includes: current controlling, by the load apparatus, that includes controlling a current that is output from the load apparatus so that the network apparatus detects a transition state of the load apparatus; selecting, by the network apparatus, a power supply for supplying electric power to the load apparatus from among a first power supply stably supplying a certain amount of electric power and a second power supply which is the power accumulating unit, in accordance with the transition state of the load apparatus detected based on a measured value of the current that is output from the load apparatus and an amount of accumulated electric power in the power accumulating unit; and supplying electric power by the network apparatus, which is input from the first power supply or the second power supply selected at the selecting, to the load apparatus via a network cable.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an electric power supply system according to a first embodiment;

FIG. 2 is a block diagram illustrating a hub according to the first embodiment;

FIG. 3 is a sequence diagram illustrating power supply switching according to the first embodiment;

FIG. 4 is a sequence diagram illustrating power supply switching according to the first embodiment;

FIG. 5 is a flowchart illustrating control procedure according to the first embodiment;

FIG. 6 is a flowchart illustrating control procedure according to the first embodiment;

FIG. 7 is a flowchart illustrating control procedure according to the first embodiment;

FIG. 8 is a flowchart illustrating control procedure according to the first embodiment;

FIG. 9 is a flowchart illustrating control procedure according to the first embodiment;

FIG. 10 is a block diagram illustrating an electric power supply system according to a second embodiment;

FIG. 11 is a block diagram illustrating a switch according to the second embodiment; and

FIG. 12 is a block diagram illustrating a hub according to the second embodiment.

### DETAILED DESCRIPTION OF THE PREFERRED EMBODIMENTS

Embodiments of a network apparatus, an electric power supply system, and an electric power supply method will be hereinafter explained in detail with reference to appended drawings.

### First Embodiment

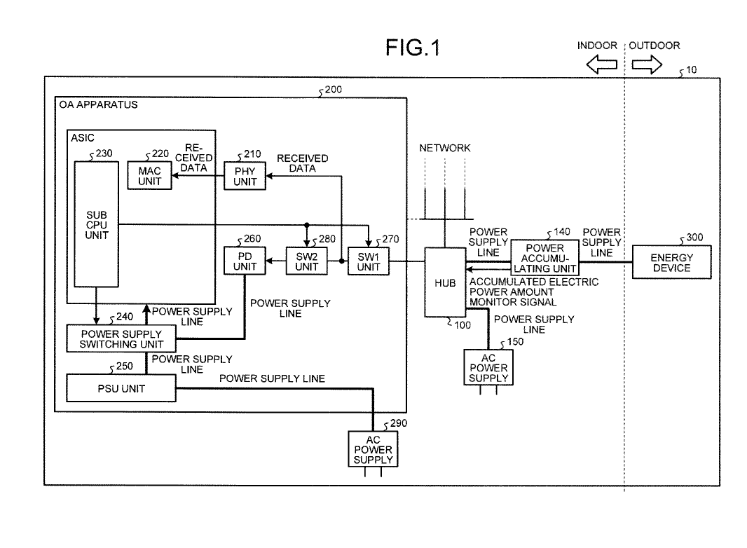

FIG. 1 is a block diagram illustrating an electric power supply system 10 according to the first embodiment. As illustrated in FIG. 1, the electric power supply system according to the first embodiment includes a hub (HUB) 100, a power accumulating unit 140, an OA apparatus 200, and an energy device 300. It should be noted that the hub 100 and the OA apparatus 200 are connected via a network cable.

The hub 100 is an example of a network apparatus capable of supplying electric power to a load apparatus via a network cable. The network apparatus is installed between communicating network devices, and the network apparatus is an apparatus for, e.g., transferring, switching, and routing data. In the first embodiment, the hub 100 is used as an example in the explanation. However, this is not limited thereto. This can also be applied to other network apparatuses such as a switching hub and a router in the same manner.

In the first embodiment, the hub 100 supports the standard of PoE (Power over Ethernet (registered trademark)) defined in IEEE (the Institute of Electrical and Electronics Engineers) 802.3at and IEEE 802.3af. The PoE is a technique for supplying electric power to a load apparatus via a UTP (Unshielded Twist Pair) cable of category 5 or higher which is used for wiring of Ethernet. The hub 100 has input from the power supply of each of an AC power supply 150 and the power accumulating unit 140. More specifically, in the first embodiment, the hub 100 selectively supplies to the OA apparatus 200 any one of electric power which is input from the AC power supply 150 and electric power which is input from the power accumulating unit 140. The AC power supply 150 is an example of power supply stably supplying a certain amount of electric power.

The power accumulating unit 140 is a power supply that accumulates electric power generated by the energy device 300, and that supplies the accumulated electric power to the hub 100. It should be noted that the power accumulating unit 140 may be provided inside of the hub 100.

The OA apparatus 200 is an example of load apparatus receiving supply of electric power from the hub 100, and is an MFP (Multifunction Peripheral), a copying machine, a printer, and the like. The OA apparatus 200 has input from the power supply of each of an AC power supply 290 and the hub 100. More specifically, the OA apparatus 200 selectively received supply of any one of the electric power which is input from the AC power supply 290 and the electric power which is input from the hub 100. The AC power supply 290 is an example of power supply that stably supplies a certain amount of electric power.

The energy device 300 is an example of power generation apparatus generating electric power using natural energy. In the first embodiment, the energy device 300 is solar power generation apparatus.

In this case, as illustrated in FIG. 1, in the first embodiment, the energy device 300 is installed outdoors; and on the other hand, the hub 100, the power accumulating unit 140, and the OA apparatus 200 are installed indoors. The energy device 300 is installed outdoors, and therefore, the energy device 300 can supply sufficient electric power as compared with a case where electric power is supplied by accumulating electric power using a fluorescent light. In addition, since the energy device 300 is installed outdoors, the energy device 300 may be of a larger size as compared with a case where, e.g., the energy device 300 is provided on the OA apparatus 200 itself. The hub 100 is installed indoors close to the outdoors (for example, in proximity to a window) according to the location where the energy device 300 is installed, and a network cable is installed between the hub 100 and the OA apparatus 200. Therefore, this configuration solves the issue of complicated power supply wires, and moreover, the location where the OA apparatus is installed is not limited. It is noted that the power can be supplied to the OA apparatus 200 not only by using PoE but also by using wireless connection.

Subsequently, the configuration of the CA apparatus 200 according to the first embodiment will be explained with reference to FIG. 1. In general, the OA apparatus 200 includes circuits and the like other than the units as illustrated in FIG. 1, but in the explanation below, they are not explained for the sake of convenience of explanation.

As illustrated in FIG. 1, the OA apparatus 200 according to the first embodiment includes a PHY (PHYsical Layer) unit 210, a MAC (Media Access Control) unit 220, a Sub CPU (Central Processing Unit) unit 230, a power supply switching unit 240, a PSU (Power Supply Unit) unit 250, a PD (Powered Device) unit 260, a SW (SWitch) 1 unit 270, and a SW2 unit 280. It should be noted that the MAC unit 220 and the Sub CPU unit 230 are arranged in an integrated circuit such as an ASIC (Application Specific Integrated Circuit) and the like.

The PHY unit 210 performs data conversion between data at a transmission path (i.e., at the hub 100) and data at the OA apparatus 200. It should be noted that the data at the hub 100 relies on the network cable, and are an optical signal or an electric signal. On the other hand, data at the OA apparatus 200 are a logical signal. The MAC unit 220 performs Ethernet processing on data received from the PHY unit 210.

The Sub CPU unit 230 monitors and controls the transition state of the OA apparatus 200. In this case, in the first embodiment, the transition state of the OA apparatus 200 includes “normal state” and “standby state”.

In the first embodiment, the OA apparatus 200 receives supply of electric power which is input from the AC power supply 290 when the OA apparatus 200 is in the “normal state”. In the “standby state”, the OA apparatus 200 receives supply of electric power which is input from the hub 100. Accordingly, when the Sub CPU unit 230 detects transition of the state of the CA apparatus 200 from the “normal state” to the “standby state” or from the “standby state” to the “normal state”, the Sub CPU unit 230 adopts this as a trigger, and outputs a control signal to the power supply switching unit 240, the SW1 unit 270, and the SW2 unit 280. In the first embodiment, the “normal state” and the “standby state” are considered as the transition state of the OA apparatus 200. However, the transition state of the OA apparatus 200 is not limited thereto. It is possible to configure to use any given power supply to supply electric power in any given transition state.

The power supply switching unit 240 selects a power supply, from which electric power is supplied, in accordance with the control signal received from the Sub CPU unit 230. For example, when the power supply switching unit 240 receives a signal for selecting the hub 100 as the power supply from the Sub CPU unit 230 (which may be hereinafter referred to as “PD selection signal” as necessary), the power supply switching unit 240 performs control so as to receive supply of electric power which is input from the PD unit 260. On the other hand, for example, when the power supply switching unit 240 receives a signal for selecting the AC power supply 290 as the power supply from the Sub CPU unit 230 (which may be hereinafter referred to as “AC power supply selection signal” as necessary), the power supply switching unit 240 performs control so as to receive supply of electric power which is input from the PSU unit 250. The PSU unit 250 converts electric power of alternating current which is input from the AC power supply 290 into direct current, and supplies the electric power converted into direct current to the power supply switching unit 240.

The PD unit 260 is a unit provided in an apparatus supporting the PoE (which may be hereinafter referred to as “PoE-enabled apparatus” as necessary), and is a circuit and the like for receiving supply of electric power via the network cable (for receiving electric power). The PD unit 260 has a certain level of resistance value for allowing detection of the PD unit 260 (detection of the PoE-enabled apparatus). This feature will be explained in detail when the hub 100 is explained.

The SW1 unit 270 and the SW2 unit 280 cooperates with each other under the control of the Sub CPU unit 230, and causes the hub 100 to recognize that the OA apparatus 200 is a PoE-enabled apparatus (or, the OA apparatus 200 is using PoE-enabled function) or that the OA apparatus 200 is not a PoE-enabled apparatus (or, the OA apparatus 200 is not using PoE-enabled function).

First, the SW1 unit 270 controls ON/OFF state of the path of the network cable connected from the hub 100. The “OFF” state is equivalent to disconnection of the network cable connected to the hub 100. The “ON” state is equivalent to insertion of the network cable connected to the hub 100. More specifically, when the hub 100 detects that an apparatus is connected to the other end of the network cable connected to the hub 100, the hub 100 adopts this as a trigger, and applies a voltage to the connected apparatus for the purpose of detecting whether this apparatus is a PoE-enabled apparatus (or, this apparatus is using PoE-enabled function). The network cable is not actually pulled out from or inserted into the OA apparatus 200, and instead, the ON/OFF state of the path is controlled by the SW1 unit 270, so that a trigger for detecting whether the apparatus is a PoE-enabled apparatus or not is given to the hub 100.

The SW2 unit 280 controls the ON/OFF state of the path from the SW1 unit 270 to the PD unit 260. As described above, when the path is controlled by the SW1 unit 270 so that the path is changed from the “OFF” state to the “ON” state; this is adopted as a trigger, and the hub 100 starts detection. Accordingly, before the SW1 unit 270 controls the path so as to change the path from the “OFF” state to the “ON” state, the SW2 unit 280 controls the path between the SW1 unit 270 and the PD unit 260 so as to change the path to the “ON” state or the “OFF”, whereby, when the SW1 unit 270 thereafter changes the path from the “OFF” state to the “ON” state, the hub 100 is caused to recognize that the OA apparatus 200 is a PoE-enabled apparatus or that the OA apparatus 200 is not a PoE-enabled apparatus.

More specifically, for example, when the SW2 unit 280 controls the path between the SW1 unit 270 and the PD unit 260 so as to change the path to the “ON” state before the SW1 unit 270 controls the path so as to change the path from the “OFF” state to the “ON” state, the control of the path from the “OFF” state to the “ON” state by the SW1 unit 270 is adopted as a trigger, and the hub 100 applies a voltage to the OA apparatus 200. Then, this voltage is applied to the PD unit 260, and a current according to the resistance value provided in the PD unit 260 is detected by the hub 100. This resistance value is a resistance value defined in, for example, IEEE 802.3at and IEEE 802.3af. Then, the hub 100 recognizes that the OA apparatus 200 is a “PoE-enabled apparatus (or, the OA apparatus 200 is using PoE-enabled function)”.

For example, when the SW2 unit 280 controls the path between the SW1 unit 270 and the PD unit 260 so as to change the path to the “OFF” state before the SW1 unit 270 controls the path so as to change the path from the “OFF” state to the “ON” state, the control of the path from the “OFF” state to the “ON” state by the SW1 unit 270 is adopted as a trigger, and the hub 100 applies a voltage to the OA apparatus 200. In this case, the voltage does not reach the PD unit 260, and the hub 100 does not detect a current according to the resistance value provided in the PD unit 260. Then, the hub 100 recognizes that the OA apparatus 200 is not a “PoE-enabled apparatus (or, the OA apparatus 200 is not using PoE-enabled function)”.

It should be noted that a case where it is desired to cause the hub 100 to recognize that the OA apparatus 200 is a “PoE-enabled apparatus (or, the OA apparatus 200 is using PoE-enabled function)” means a case where the OA apparatus 200 wants electric power supplied from the hub 100. In the first embodiment, this case corresponds to the “standby state”. On the other hand, a case where it is desired to cause the hub 100 to recognize that the OA apparatus 200 is not a “PoE-enabled apparatus (or, the OA apparatus 200 is not using PoE-enabled function)” means a case where the OA apparatus 200 does not want electric power supplied from the hub 100, and operates on electric power supplied from the AC power supply 290. In the first embodiment, this case corresponds to the “normal state”. In the “normal state”, the electric power generated by the energy device 300 is not consumed, and is accumulated in the power accumulating unit 140.

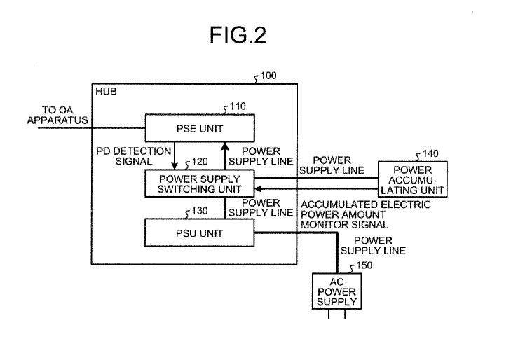

Subsequently, FIG. 2 is a block diagram illustrating the hub 100 according to the first embodiment. In general, the hub 100 includes circuits and the like other than each unit as illustrated in FIG. 2, but they are not explained for the sake of convenience of explanation.

As illustrated in FIG. 2, the hub 100 according to the first embodiment includes a PSE (Power Sourcing Equipment) unit 110, a power supply switching unit 120, and a PSU unit 130.

The PSE unit 110 is a unit provided in a network apparatus supporting the PoE. The PSE unit 110 is a circuit and the like for supplying electric power via the network cable (feeding electric power). When the PSE unit 110 detects that an apparatus (the OA apparatus 200 in the first embodiment) is connected to the other end of the network cable connected to the hub 100, this is adopted as a trigger, and applies a voltage to the connected apparatus for the purpose of detecting whether this apparatus is a PoE-enabled apparatus (or, this apparatus is using PoE-enabled function). The PSE unit 110 measures a current from the connected apparatus, and determines, on the basis of this measured value, whether this apparatus is a PoE-enabled apparatus or not. The PSE unit 110 generates a signal representing a determination result (which may be hereinafter referred to as “PD detection signal” as necessary), and outputs the PD detection signal to the power supply switching unit 120.

The power supply switching unit 120 selects, in accordance with the PD detection signal received from the PSE unit 110, a power supply that supplies electric power to the apparatus connected to the other end of the network cable (the OA apparatus 200 in the first embodiment). For example, when the power supply switching unit 120 receives a PD detection signal indicating that the apparatus is not a PoE-enabled apparatus (or, this apparatus is not using PoE-enabled function) from the PSE unit 110, the power supply switching unit 120 performs control so as to use electric power which is input from the PSU unit 130. In this case, the electric power which is input from the PSU unit 130 is not supplied to the OA apparatus 200, but is used as the electric power consumed by the hub 100.

On the other hand, for example, when the power supply switching unit 120 receives a PD detection signal indicating that the apparatus is a PoE-enabled apparatus (or, this apparatus is using PoE-enabled function) from the PSE unit 110, the power supply switching unit 120 selects the power supply for supplying electric power to the OA apparatus 200 in accordance with the amount of electric power accumulated in the power accumulating unit 140. More specifically, for example, the power supply switching unit 120 receives, from the power accumulating unit 140, a signal representing the amount of electric power accumulated in the power accumulating unit 140 (which may be hereinafter referred to as “accumulated electric power amount monitor signal” as necessary), and when the amount of accumulated electric power indicated by the accumulated electric power amount monitor signal is more than a predetermined threshold value (when a sufficient amount of electric power is accumulated), the power accumulating unit 140 is selected as the power supply for supplying electric power to the OA apparatus 200. Then, the power supply switching unit 120 performs control so that the electric power which is input from the power accumulating unit 140 is supplied to the OA apparatus 200.

On the other hand, for example, when the amount of accumulated electric power indicated by the accumulated electric power amount monitor signal is less than a predetermined threshold value (when an amount of electric power is insufficiently accumulated), the power supply switching unit 120 selects the AC power supply 150 as the power supply for supplying electric power to the OA apparatus 200. Then, the power supply switching unit 120 performs control so that the electric power which is input from the AC power supply 150 is supplied to the OA apparatus 200. The accumulated electric power amount monitor signal may be exchanged between the power supply switching unit 120 and the power accumulating unit 140 when, for example, the power supply switching unit 120 requests the power accumulating unit 140 to send the accumulated electric power amount monitor signal, so that the power supply switching unit 120 receives the accumulated electric power amount monitor signal from the power accumulating unit 140. Alternatively, for example, the power accumulating unit 140 may transmit the accumulated electric power amount monitor signal to the power supply switching unit 120 with a regular interval.

The PSU unit 130 converts electric power of alternating current which is input from the AC power supply 150 into direct current, and supplies the electric power converted into direct current to the power supply switching unit 120.

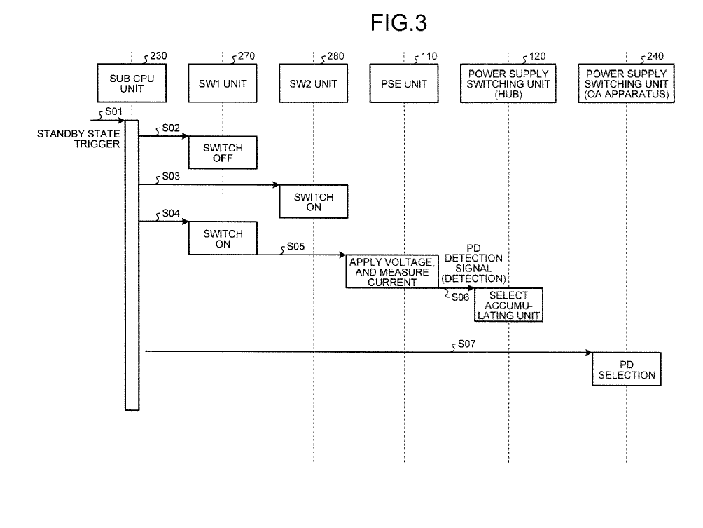

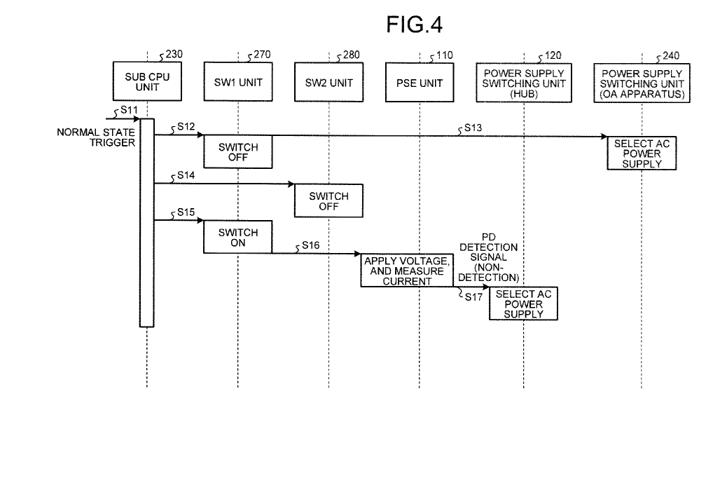

Subsequently, FIGS. 3 and 4 are sequence diagrams illustrating a power supply switching according to the first embodiment. As described above, in the first embodiment, when the OA apparatus 200 is in the “normal state”, the OA apparatus 200 receives supply of electric power which is input from the AC power supply 290, and when the OA apparatus 200 is in the “standby state”, the OA apparatus 200 receives supply of electric power which is input from the hub 100. Accordingly, in the explanation below, first, power supply switching that occurs when the state of the OA apparatus 200 changes from the “normal state” to the “standby state” will be explained with reference to FIG. 3. Subsequently, power supply switching that occurs when the state of the OA apparatus 200 changes from the “standby state” to the “normal state” will be explained with reference to FIG. 4.

As illustrated in FIG. 3, the Sub CPU unit 230 of the OA apparatus 200 monitors the state of the OA apparatus 200, and detects the transition of the state of the OA apparatus 200 from the “normal state” to the “standby state” (step S01).

The Sub CPU unit 230 adopts, as a trigger, the transition of the state of the OA apparatus 200 from the “normal state” to the “standby state”, and first, the Sub CPU unit 230 outputs a command so as to control the SW1 unit 270 so that the SW1 unit 270 changes to the “OFF” state (step S02). Then, as illustrated in FIG. 3, the SW1 unit 270 is controlled and changed to the “OFF” state, and the path of the network cable connected from the hub 100 is disconnected.

Subsequently, the Sub CPU unit 230 outputs a command so as to control the SW2 unit 280 so that the SW2 unit 280 changes to the “ON” state after a certain period of time passes since the command of step S02 is given (step S03).

The reason why the command of step S03 is output after the certain period of time passes means that the Sub CPU unit 230 waits for a period of time from when the command is output in step S02 to when the path is completely disconnected by the SW1 unit 270 (the time is counted within the Sub CPU unit 230). Then, as illustrated in FIG. 3, the SW2 unit 280 is controlled so that the SW2 unit 280 changes to the “ON” state, and the path from the SW1 unit 270 to the PD unit 260 is connected.

Subsequently, the Sub CPU unit 230 outputs a command so as to control the SW1 unit 270 so that the SW1 unit 270 changes to the “ON” state after a certain period of time passes since the command is given in step S03 (step S04). The reason why the command of step S04 is output after the certain period of time passes means that the Sub CPU unit 230 waits for a period of time from when the command is output in step S03 to when the path is completely connected by the SW2 unit 280 (the time is counted within the Sub CPU unit 230). Then, as illustrated in FIG. 3, the SW1 unit 270 is controlled so that the SW1 unit 270 changes to the “ON” state, and the path of the network cable connected from the hub 100 is connected.

When the path of the network cable connected from the hub 100 is connected at the OA apparatus 200, the PSE unit 110 of the hub 100 detects that an apparatus (the OA apparatus 200 in the first embodiment) is connected to the other end of the network cable. Then, when the PSE unit 110 adopts this as a trigger and applies a voltage to the connected OA apparatus 200, this voltage is applied to the PD unit 260, and a current according to the resistance value provided in the PD unit 260 is detected by the PSE unit 110 (step S05).

Then, the PSE unit 110 determines that the OA apparatus 200 is a “PoE-enabled apparatus (or, using PoE-enabled function)”, generates a PD detection signal (detection) indicating the determination result thereof, and outputs the PD detection signal to the power supply switching unit 120 (step S06).

When the power supply switching unit 120 receives the PD detection signal (detection) from the PSE unit 110, the power supply switching unit 120 further determines whether the amount of electric power accumulated in the power accumulating unit 140 is more than a predetermined threshold value. For example, the amount of accumulated electric power is determined to be more than the predetermined threshold value (when a sufficient amount of electric power is accumulated), as illustrated in FIG. 3, the power accumulating unit 140 is selected as the power supply for supplying electric power to the OA apparatus 200. Then, the power supply switching unit 120 performs control so that the electric power which is input from the power accumulating unit 140 is supplied to the OA apparatus 200.

On the other hand, after a certain period of time passes since the command is output to the SW1 unit 270 in step S04, the Sub CPU unit 230 of the OA apparatus 200 outputs a PD selection signal to the power supply switching unit 240 (step S07). In step S04, the time required from when the hub 100 connects the path of the network cable to when the hub 100 becomes ready to stably supply electric power is often defined as the specification at the hub 100. Therefore, the Sub CPU unit 230 may wait for the period of time defined in this specification.

Then, when the power supply switching unit 240 receives the PD selection signal from the Sub CPU unit 230, the power supply switching unit 240 performs control so as to receive supply of electric power which is input from the PD unit 260.

As described above, when the state changes from the “normal state” to the “standby state”, the OA apparatus 200 allows the hub 100 to recognize that the OA apparatus 200 has changed to the state of using the PoE-enabled function by making use of cooperation of the SW1 unit 270 and the SW2 unit 280; and the hub 100 can select an appropriate power supply in accordance with the state of the OA apparatus 200 and the amount of accumulated electric power of the power accumulating unit 140.

Subsequently, as illustrated in FIG. 4, the Sub CPU unit 230 of the OA apparatus 200 monitors the state of the OA apparatus 200, and detects the transition of the state of the OA apparatus 200 from the “standby state” to the “normal state” (step S11).

The Sub CPU unit 230 adopts, as a trigger, the transition of the state of the OA apparatus 200 from the “standby state” to the “normal state”, and first, the Sub CPU unit 230 outputs a command so as to control the SW1 unit 270 so that the SW1 unit 270 changes to the “OFF” state (step S12), and outputs an AC power supply selection signal to the power supply switching unit 240 (step S13). It should be noted that the Sub CPU unit 230 preferably execute step S13 when the OA apparatus 200 becomes ready to receive supply of electric power from the AC power supply 290 at least before the path of the network cable connected from the hub 100 is disconnected.

Subsequently, after a certain period of time passes since the command is given in step S12, the Sub CPU unit 230 outputs a command so as to control the SW2 unit 280 so that the SW2 unit 280 changes to the “OFF” state (step S14). The reason why the command of step S14 is output after the certain period of time passes means that the Sub CPU unit 230 waits for a period of time from when the command is output in step S12 to when the path is completely disconnected by the SW1 unit 270 (the time is counted within the Sub CPU unit 230). Then, as illustrated in FIG. 4, the SW2 unit 280 is controlled so that the SW2 unit 280 changes to the “OFF” state, and the path from the SW1 unit 270 to the PD unit 260 is disconnected.

Subsequently, the Sub CPU unit 230 outputs a command so as to control the SW1 unit 270 so that the SW1 unit 270 changes to the “ON” state after a certain period of time passes since the command is given in step S14 (step S15). The reason why the command of step S15 is output after the certain period of time passes means that the Sub CPU unit 230 waits for a period of time from when the command is output in step S14 to when the path is completely disconnected by the SW2 unit 280 (the time is counted within the Sub CPU unit 230). Then, as illustrated in FIG. 4, the SW1 unit 270 is controlled so that the SW1 unit 270 changes to the “ON” state, and the path of the network cable connected from the hub 100 is connected.

When the path of the network cable, connected from the hub 100, is connected at the OA apparatus 200; the PSE unit 110 of the hub 100 detects that an apparatus (the OA apparatus 200 in the first embodiment) is connected to the other end of the network cable. Then, when the PSE unit 110 adopts this as trigger and applies a voltage to the connected OA apparatus 200, this voltage is not applied to the PD unit 260, and a current according to the resistance value provided in the PD unit 260 is not detected by the PSE unit 110 (step S16).

Then, the PSE unit 110 determines that the OA apparatus 200 is not a “PoE-enabled apparatus (or, not using PoE-enabled function)”, generates a PD detection signal (non-detection) indicating the determination result thereof, and outputs the PD detection signal to the power supply switching unit 120 (step S17).

When the power supply switching unit 120 receives the PD detection signal (non-detection) from the PSE unit 110, the power supply switching unit 120 selects the AC power supply 150 as the power supply for supplying electric power to the OA apparatus 200 as illustrated in FIG. 4. Then, the power supply switching unit 120 performs control so as to use the electric power which is input from the PSU unit 130. In this case, the electric power which is input from the PSU unit 130 is not supplied to the OA apparatus 200, but is used as the electric power consumed by the hub 100.

As described above, when the state changes from the “standby state” to the “normal state”, the OA apparatus 200 allows the hub 100 to recognize that the OA apparatus 200 has changed to the state of not using the PoE-enabled function by making use of cooperation of the SW unit 270 and the SW2 unit 280, and the hub 100 can select an appropriate power supply in accordance with the state of the OA apparatus 200.

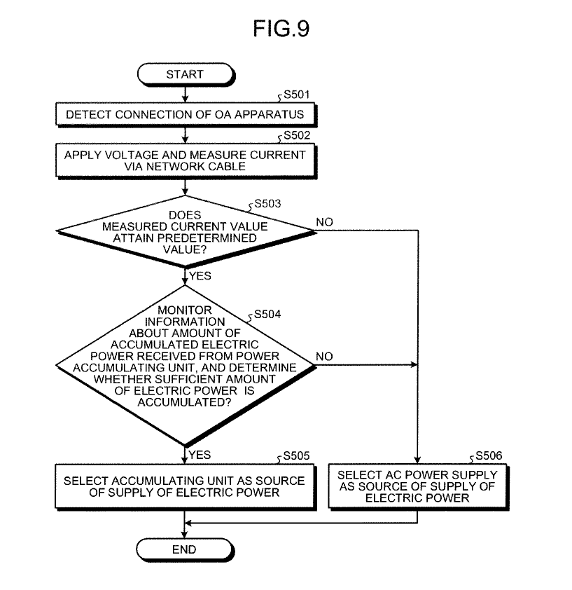

Subsequently, FIGS. 5 to 9 are flowcharts illustrating control procedure according to the first embodiment. FIGS. 5 to 8 illustrate control procedure performed by the Sub CPU unit 230 of the OA apparatus 200. FIG. 9 illustrates control procedure performed by the PSE unit 110 of the hub 100.

As illustrated in FIG. 5, when the Sub CPU unit 230 of the OA apparatus 200 detects transition of the state of the OA apparatus 200 from the “normal state” to the “standby state” (step S101); first, the Sub CPU unit 230 controls the SW1 unit 270 so that the SW1 unit 270 changes to the “OFF” state (step S102). Then, the Sub CPU unit 230 waits for a time until the path is completely disconnected by the SW1 unit 270 (step S103); and thereafter, the SW2 unit 280 is controlled so that the SW2 unit 280 changes to the “ON” state (step S104). Then, the Sub CPU unit 230 further waits for a time until the path is completely connected by the SW2 unit 280 (step S105), and thereafter, the SW1 unit 270 is controlled so that the SW1 unit 270 changes to the “ON” state (step S106).

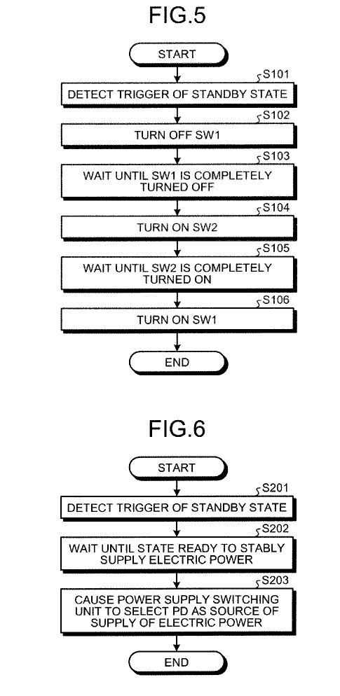

As illustrated in FIG. 6, when the Sub CPU unit 230 detects transition of the state of the OA apparatus 200 from the “normal state” to the “standby state” (step S201), the Sub CPU unit 230 waits for a time until the hub 100 becomes ready to stably supply electric power (step S202), and outputs a PD selection signal to the power supply switching unit 240 (step S203).

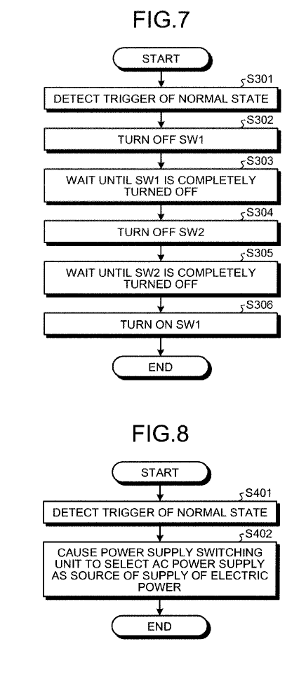

As illustrated in FIG. 7, when the Sub CPU unit 230 detects transition of the state of the OA apparatus 200 from the “standby state” to the “normal state” (step S301), first, the Sub CPU unit 230 controls the SW1 unit 270 so that the SW1 unit 270 changes to the “OFF” state (step S302). Then, the Sub CPU unit 230 waits for a time until the path is completely disconnected by the SW1 unit 270 (step S303), and thereafter, the SW2 unit 280 is controlled so that the SW2 unit 280 changes to the “OFF” state (step S304). Then, the Sub CPU unit 230 further waits for a time until the path is completely disconnected by the SW2 unit 280 (step S305), and thereafter, the SW1 unit 270 is controlled so that the SW1 unit 270 changes to the “ON” state (step S306).

As illustrated in FIG. 8, when the Sub CPU unit 230 detects transition of the state of the CA apparatus 200 from the “standby state” to the “normal state” (step S401), the Sub CPU unit 230 immediately outputs an AC power supply selection signal to the power supply switching unit 240 (step S402).

As illustrated in FIG. 9, when the PSE unit 110 of the hub 100 detects that the OA apparatus 200 is connected to the other end of the network cable (step S501), the PSE unit 110 applies a voltage to the connected OA apparatus 200 via the network cable, and measures the current (step S502).

Then, first, the PSE unit 110 determines whether the measured current value attains a predetermined value (the current value according to the resistance value provided in the PD unit 260) (step S503). When the measured current value is determined to attain the predetermined value as a result of the determination (step S503, positive), the PSE unit 110 monitors information about the amount of accumulated electric power received from the power accumulating unit 140, and determines whether the amount of accumulated electric power is more than a predetermined threshold value (a sufficient amount of electric power is accumulated) (step S504).

Then, when the amount of accumulated electric power is determined to be more than the predetermined threshold value (a sufficient amount of electric power is determined to be accumulated) (step S504, positive), the PSE unit 110 selects the power accumulating unit 140 as a source of supply of electric power supplied to the OA apparatus 200 (step S505).

On the other hand, when, in step S503, the measured current value is determined not to attain the predetermined value (the current value according to the resistance value provided in the PD unit 260) (step S503, negative), and, in step S504, the amount of accumulated electric power is less than the predetermined threshold value (when a sufficient amount of electric power is not accumulated) (step S504, negative), the PSE unit 110 selects the AC power supply 150 as a source of supply of electric power (step S506). In particular, when the measured current value is determined not to have attained the predetermined value (the current value according to the resistance value provided in the PD unit 260) (step S503, negative), the electric power which is input from the AC power supply 150 is not supplied to the OA apparatus 200, and is used by the hub 100.

As described above, according to the first embodiment, the electric power generated by the energy device 300 is supplied to the OA apparatus 200 via the hub 100, and therefore, the location where the energy device 300 is installed can be flexibly set, and the location where the OA apparatus 200 is installed can be flexibly set, so that the electric power can be supplied appropriately.

For example, according to the first embodiment, when the energy device 300 is provided outdoors, a sufficient amount of electric power can be supplied, and the energy device 300 may be of a large size. Even when the hub 100 is installed indoors close to the outdoors (for example, in proximity to a window) according to the location where the energy device 300 is installed, the network cable installed between the hub 100 and the OA apparatus 200 solves the issue of complicated power supply wires, and moreover, the location where the OA apparatus is installed is not limited.

According to the first embodiment, the hub 100 detects the transition state of the OA apparatus 200 on the basis of the measured value of the current which is output from the OA apparatus 200, and the power supply is selected in accordance with the detected transition information and the amount of accumulated electric power. Therefore, according to the first embodiment, the hub 100 can recognize the transition state of the OA apparatus 200 using a simple method, and the hub 100 can select an appropriate power supply in accordance with the transition information and the amount of accumulated electric power.

### Second Embodiment

Subsequently, an electric power supply system 15 according to the second embodiment will be explained. The first embodiment employs the method in which the hub 100 determines whether the amount of accumulated electric power of the power accumulating unit 140 is sufficient or not, and in accordance with this determination result, the power supply is selected. With regard to this feature, in the second embodiment, multiple types of energy devices are considered, and the second embodiment employs a method in which an OA apparatus 200 selects an optimum power supply from among various types of power supplies including multiple types of energy devices, and a hub 105 is caused to recognize the selected power supply.

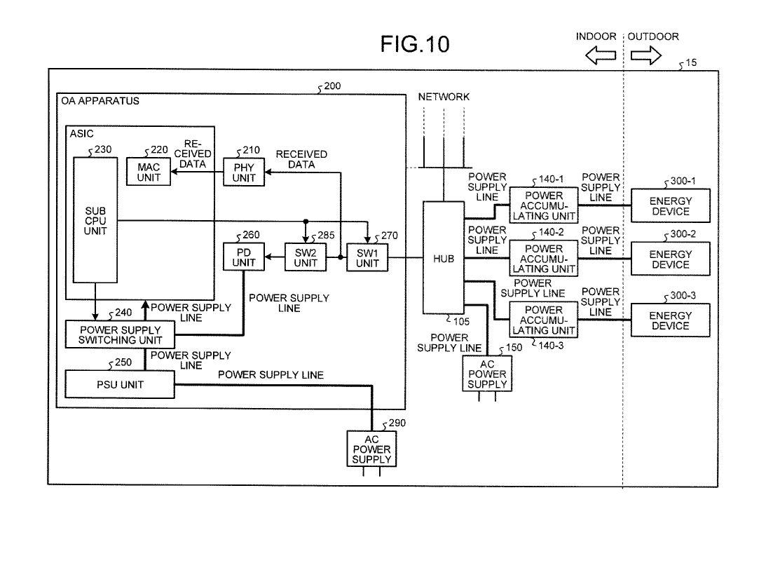

FIG. 10 is a block diagram illustrating an electric power supply system 15 according to the second embodiment. As illustrated in FIG. 10, the electric power supply system according to the second embodiment is different from the first embodiment in that the electric power supply system according to the second embodiment includes multiple energy devices 300 and multiple power accumulating units 140. As described later, the configurations of the SW2 unit 285 of the OA apparatus 200 and the hub 105 are different from those of the first embodiment. When the other units perform operation different from the first embodiment, the operation will be explained as necessary. When the other units perform the same operation as the first embodiment, explanation thereabout is omitted as necessary.

As illustrated in FIG. 10, the electric power supply system 15 according to the second embodiment has multiple energy devices 300. The energy devices 300-1 to 300-3 are, for example, solar light power generation apparatus, hydraulic power generation apparatus, wind power generation apparatus, and the like. In this case, each energy device 300 uses different types of natural energies for power generation, and therefore, a different energy device 300 is considered to produce much accumulation of electric power, depending on conditions such as weather.

Therefore, in the second embodiment, the OA apparatus 200 obtains, for example, weather observation data serving as information related to the amount of accumulated electric power of each of the power accumulating units 140-1 to 140-3; and on the basis of the obtained weather observation data, an optimum energy device 300 is selected.

For example, the OA apparatus 200 obtains the weather observation data using, e.g., an input given by a user and an input given from a network, and inputs the obtained weather observation data into the Sub CPU unit 230. For example, the weather observation data are precipitation, temperature, wind direction, wind speed, sunshine hours, and the like. Subsequently, the Sub CPU unit 230 analyzes the obtained weather observation data using predetermined algorithm, and constantly determines the amount of accumulated electric power produced by which of the solar light energy device 300-1, the hydraulic energy device 300-2, and the wind power energy device 300-3 is the highest, thus selecting power supply adopted as a source of supply of electric power.

The predetermined algorithm may be as follows, for example. When the sunshine hours in a certain period of time in the past are long, the point of the solar light energy device 300-1 is increased in accordance with the sunshine hours. When the precipitation in a certain period of time in the past is much, the point of the hydraulic energy device 300-2 is increased in accordance with the precipitation. When the wind speed in a certain period of time in the past is strong, the point of the wind energy device 300-3 is increased in accordance with a time in which there was a high wind speed. A determination may be made on the basis of the total point of each of the energy devices 300 in view of the number of times of selection in the past. Further, when none of the total points of the energy devices 300 attains a predetermined point, the AC power supply 150 may be determined to be selected. It should be noted that the algorithm is not limited to the above algorithm, and, for example, the algorithm may be an algorithm using a predictive model representing correlation between the weather observation data and the amount of accumulated electric power. As described above, the algorithm may be freely defined.

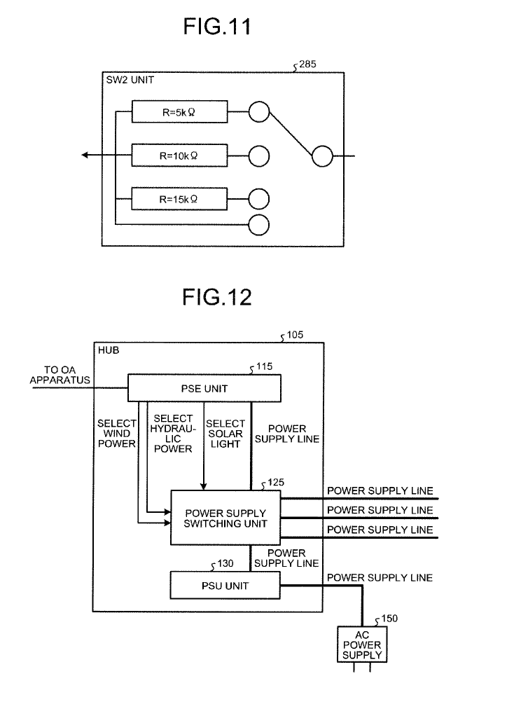

Subsequently, the Sub CPU unit 230 causes the hub 105 to recognize the selected power supply. FIG. 11 is a block diagram illustrating a switch (SW2 unit 285) according to the second embodiment. As illustrated in FIG. 11, in the second embodiment, the SW2 unit 285 is configured to be able to select a resistance value (“R” in FIG. 11) in accordance with the selection result provided by the Sub CPU unit 230.

In this case, for example, the following definition is set in advance: when the hub 105 measures a measured value of current corresponding to the resistance value “5 kΩ”, this means that the solar light energy device 300-1 is selected. When the hub 105 measures a measured value of current corresponding to the resistance value “10 kΩ”, this means that the hydraulic energy device 300-2 is selected. When the hub 105 measures a measured value of current corresponding to the resistance value “15 kΩ”, this means that the wind energy device 300-3 is selected. When the hub 105 measures a measured value of current corresponding to the resistance value “50 kΩ”, this means that the AC power supply 150 is selected. The hub 105 is configured to be able to recognize the selection of them.

In such case, when the Sub CPU unit 230 controls the SW2 unit 285 so as to select the path of the resistance value “5 kΩ” in the SW2 unit 285, the hub 105 measures the current value, and detects selection of the solar light energy device 300-1. Even when other energy devices 300 are selected, the above process is applicable.

FIG. 12 is a block diagram illustrating the hub 105 according to the second embodiment. When the units as illustrated in FIG. 12 perform operation different from the first embodiment, such operation will be explained below as necessary. When the units as illustrated in FIG. 12 perform the same operation as the first embodiment, explanation thereabout will be omitted as necessary.

Like the first embodiment, when an PSE unit 115 detects that the OA apparatus 200 is connected to the other end of the network cable connected to the hub 105, the PSE unit 115 adopts this as a trigger, and applies a voltage to the connected OA apparatus 200. In this case, in the first embodiment, a determination as to whether this apparatus is a PoE-enabled apparatus (or, this apparatus is using PoE-enabled function) in accordance with the measured value. In the second embodiment, however, in addition to this determination, a determination is made as to whether which power supply is selected by the OA apparatus 200.

More specifically, as described above, when the PSE unit 115 measures a measured value of current corresponding to the resistance value “5 kΩ”, the PSE unit 115 determines that the solar light energy device 300-1 is selected. When the PSE unit 115 measures a measured value of current corresponding to the resistance value “10 kΩ”, the PSE unit 115 determines that the hydraulic energy device 300-2 is selected. When the PSE unit 115 measures a measured value of current corresponding to the resistance value “15 kΩ”, the PSE unit 115 determines that the wind power energy device 300-3 is selected. When the PSE unit 115 measures a measured value of current corresponding to the resistance value “50 kΩ”, the PSE unit 115 determines that the AC power supply 150 is selected. For example, when the PSE unit 115 measures a measured value other than the above, the PSE unit 115 determines that the OA apparatus 200 is not a PoE-enabled apparatus (or, the CA apparatus 200 is not using PoE-enabled function). Then, like the first embodiment, the PSE unit 115 generates a PD detection signal representing the determination result, and outputs the PD detection signal to a power supply switching unit 125.

The power supply switching unit 125 selects a power supply supplying electric power to the OA apparatus 200 connected to the other end of the network cable in accordance with the PD detection signal received from the PSE unit 115. For example, the power supply switching unit 125 selects a power supply from among: the AC power supply 150, the power accumulating unit 140-1, the power accumulating unit 140-2, and the power accumulating unit 140-3, in accordance with the PD detection signal received from the PSE unit 115.

As described above, according to the second embodiment, electric powers generated by multiple types of natural energies can be selected, and therefore, an optimum power supply can be selected in accordance with weather. For example, even when the weather is not fine, electric powers generated by various kinds of natural energies such as hydraulic power generation and wind power generation can be selected.

According to the second embodiment, an optimum power supply is selected by the OA apparatus 200, and the hub 105 is caused to recognize the selection of the power supply made by the OA apparatus 200 using a simple method. Therefore, advanced selection can be achieved using a simple method.

A program including the processing procedure executed by the Sub CPU unit 230 of the first embodiment, a program including the processing procedure executed by the PSE unit 110, a program including the processing procedure executed by the Sub CPU unit 230 of the second embodiment, and a program including the processing procedure executed by the PSE unit 115 may be provided as being incorporated into a ROM (Read Only Memory) and the like. Alternatively, each program may be configured to be provided as being recorded as a file in an installable format or in an executable format to a computer-readable recording medium such as a CD (Compact Disc)-ROM, a flexible disk (FD), a CD-R, a DVD (Digital Versatile Disk), and the like. Further, each program may be provided in such a manner that each program is stored to a computer connected to a network such as the Internet to allow download via the network. Each program may be configured to be provided or distributed via a network such as the Internet.

Each program is made as a module configuration including each processing procedure explained above, and as actual hardware, the CPU reads and executes them from the ROM, so that each processing procedure is loaded to a main storage device, and each processing procedure is generated on the main storage device.

According to the embodiment, an effect that electric power can be appropriately supplied to a load apparatus is achieved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A network apparatus comprising:
a selection unit that selects a power supply for supplying electric power to a load apparatus from among
a first power supply stably supplying a certain amount of electric power and
a second power supply that is a power accumulating unit for accumulating electric power generated by natural energy, in accordance with
a transition state of the load apparatus and
an amount of accumulated electric power in the power accumulating unit; and
a supply unit that supplies electric power input from the first power supply or the second power supply selected by the selection unit to the load apparatus via a network cable.

2. The network apparatus according to claim 1, wherein
the selection unit
detects the transition state of the load apparatus based on a measured value of a current that is output from the load apparatus, and
selects a power supply which supplies electric power to the load apparatus in accordance with the detected transition state and the amount of accumulated electric power.

3. The network apparatus according to claim 1, wherein
the second power supply includes a plurality of power accumulating units respectively corresponding to electric powers generated by a plurality of types of natural energies, and
the selection unit selects a power supply, which is selected by the load apparatus in accordance with the amount of accumulated electric power in each of the power accumulating units, as a power supply that supplies electric power to the load apparatus.

4. The network apparatus according to claim 3, wherein
the selection unit
detects the power supply selected by the load apparatus based on a measured value of a current that is output from the load apparatus, and
selects the power supply that supplies electric power to the load apparatus.

5. An electric power supply system comprising a load apparatus and a network apparatus supplying electric power to the load apparatus via a network cable, wherein
the electric power supply system further includes:
a power generation apparatus that generates electric power by natural energy; and
a power accumulating unit that accumulates electric power generated by the power generation apparatus,
the load apparatus includes
a current control unit that controls a current that is output from the load apparatus so that the network apparatus detects a transition state of the load apparatus, and
the network apparatus includes:
a selection unit that selects a power supply for supplying electric power to the load apparatus, from among a first power supply stably supplying a certain amount of electric power and a second power supply which is the power accumulating unit, in accordance with
the transition state of the load apparatus detected based on a measured value of the current that is output from the load apparatus and
an amount of accumulated electric power in the power accumulating unit; and
a supply unit that supplies electric power, which is input from the first power supply or the second power supply selected by the selection unit, to the load apparatus via the network cable.

6. The electric power supply system according to claim 5, wherein
the load apparatus includes:
a current output unit that outputs a current to the network apparatus; and
a first switch and a second switch that are provided on a path connecting the current output unit and the network cable, and
the current control unit controls ON and OFF states of the first switch and the second switch and an order of the ON and OFF states, thereby controlling the current that is output from the current output unit to the network apparatus.

7. The electric power supply system according to claim 5, wherein
the second power supply includes a plurality of power accumulating units respectively corresponding to a plurality of power generation apparatuses that generate electric powers by a plurality of types of natural energies, and
the selection unit of the network apparatus selects a power supply, which is selected by the load apparatus in accordance with the amount of accumulated electric power in each of the power accumulating units, as a power supply that supplies electric power to the load apparatus.

8. The electric power supply system according to claim 7, wherein the load apparatus includes:
a power supply selection unit that
obtains information about the amount of accumulated electric power of each of the power accumulating units, and
selects a power supply which is adopted as a source of supply of electric power based on the information;
a current output unit that outputs a current to the network apparatus;
a first switch provided on a path connecting the current output unit and the network cable; and
a second switch configured to select a resistance value in accordance with a selection result selected by the power supply selection unit, wherein
the current control unit controls ON and OFF states of the first switch and the second switch, an order of the ON and OFF states, and the resistance value selected by the second switch, thereby controlling the current that is output from the current output unit to the network apparatus, and
the selection unit of the network apparatus detects the power supply selected by the load apparatus, based on a measured value of the current that is output from the load apparatus, and selects the power supply that supplies electric power to the load apparatus.

9. An electric power supply method executed by an electric power supply system including a load apparatus and a network apparatus that supplies electric power to the load apparatus via a network cable, wherein
the electric power supply system further includes:
a power generation apparatus that generates electric power by natural energy; and
a power accumulating unit that accumulates the electric power generated by the power generation apparatus,
the method comprising:
current controlling, by the load apparatus, that includes controlling a current that is output from the load apparatus so that the network apparatus detects a transition state of the load apparatus;
selecting, by the network apparatus, a power supply for supplying electric power to the load apparatus from among a first power supply stably supplying a certain amount of electric power and a second power supply which is the power accumulating unit, in accordance with the transition state of the load apparatus detected based on a measured value of the current that is output from the load apparatus and an amount of accumulated electric power in the power accumulating unit; and
supplying electric power by the network apparatus, which is input from the first power supply or the second power supply selected at the selecting, to the load apparatus via a network cable.
